(19) United States
(12) Patent Application Publication
(10) Pub. No.: US 2003/0070858 A1
(43) Pub. Date: Apr. 17, 2003

(54) Mounting structure of a fuel cell stack to a vehicle

(76) Inventor: Toshiyuki Kondo, Tiryu-shi (JP)

Correspondence Address: KENYON & KENYON, 1500 K STREET, N.W., SUITE 700, WASHINGTON, DC, 20005, US

(21) Appl. No.: 10/243,824

(22) Filed: Sep. 16, 2002

(30) Foreign Application Priority Data
Oct. 12, 2001 (JP) 2001-315221

(51) Int. Cl. B60K 1/00

(52) U.S. Cl. 180/291

(57) ABSTRACT

A fuel cell stack is located close to a cabin in at least one of a front compartment and a rear compartment of a vehicle, with the longitudinal direction of the fuel cell stack oriented transversely to the vehicle's longitudinal axis. The fuel cell stack is located closer to the cabin than an energy absorbing portion of a vehicle side member. A vehicle cross member is disposed farther from the cabin than the fuel cell stack. A cover covering the fuel cell stack is provided. The fuel cell stack is mounted via a mount having a force limiter to the vehicle side member. A bumper is provided for stopping the fuel cell stack at an end of the movement of the fuel cell stack permitted by the force limiter.

### BACKGROUND OF THE INVENTION

1. Field of the Invention

The present invention relates to a mounting structure of a fuel cell (for example, PEFC) stack to a vehicle.

2. Description of Related Art

A PEFC (Polymer Electrolyte Fuel Cell) apparatus includes individual fuel cells. Each fuel cell includes a membrane-electrode assembly (MEA) and a separator. The MEA includes an electrolyte membrane and a pair of electrodes disposed on opposite sides of the electrolyte membrane. The pair of electrodes includes an anode provided on one side of the membrane and constructed of a first catalyst layer and a cathode provided on the other side of the membrane and constructed of a second catalyst layer. A first diffusion layer may be provided between the first catalyst layer and a first separator and a second diffusion layer may be provided between the second catalyst layer and a second separator. The first separator has a passage formed therein for supplying fuel gas (hydrogen) to the anode and the second separator has a passage formed therein for supplying oxidant gas (oxygen, usually, air) to the cathode. At least one layer of the fuel cell 1 constructs a module. A number of modules are piled, and electrical terminals, electrical insulators, and end plates are disposed at opposite ends of the pile of modules to construct a stack of fuel cells. After tightening the stack of fuel cells between the opposite end plates in a fuel cell stacking direction, the end plates are coupled to a fastening member (for example, a tension plate) extending in a fuel cell stacking direction outside the pile of fuel cells by bolts extending perpendicularly to the fuel cell stacking direction.

In the PEFC, at the anode, hydrogen is changed to positively charged hydrogen ions (i.e., protons) and electrons. The hydrogen ions move through the electrolyte membrane to the cathode where the hydrogen ions react with oxygen supplied and electrons (which are generated at an anode of the adjacent MEA and move to the cathode of the instant MEA through a separator) to form water as follows:

At the anode: H₂→2H⁺+2e⁻

At the cathode: 2H⁺+2e⁻+(½)O₂→H₂O

In order that the above reaction is conducted, fuel gas and oxidant gas are supplied to the stack. Further, since the fuel cell temperature rises due to the heat generated at the water production reaction and a Joulean heat, a coolant passage is formed at every cell or at every module, and a coolant (usually, cooling water) is caused to flow in the coolant passage.

Since the fuel cell stack is a pile of fuel cells and reactant gas flows in the stack, when the stack receives a large shock or a large G (acceleration), the fuel cells may be dislocated relative to each other and leakage of fluids may occur. Therefore, the fuel cell stack should be protected from a shock and G caused at vehicle collision and a sufficient safety should be assured.

Japanese Patent Publication No. HEI 08-192639 discloses a mounting structure of a fuel cell stack to a vehicle where a fuel cell stack is placed in a front compartment located in front of a cabin. In the structure, a fuel cell stacking direction of the fuel cell stack is directed in a front-and-rear direction of the vehicle, and beneath the fuel cell stack an energy absorbing portion (a crushable portion) of a vehicle side member is located.

With the above conventional mounting structure, there is an advantage that the fuel cell stack is unlikely to cause a dislocation between fuel cells and a leakage of fluids, because the stacking direction of the fuel cell stack is directed in the front-and-rear direction of the vehicle and the fuel cell stack receives a shock load at a fuel cell plane perpendicular to the direction of the shock. However, with the conventional mounting structure of Japanese Patent Publication No. HEI 08-192639, there is a problem that since the fuel cell stacking direction is directed in the front-and-rear direction of the vehicle and the fuel cell stack extends toward the front above the crushable portion of the vehicle side member, when the vehicle is involved in a front collision and the crushable portion of the vehicle side member is deformed, a deformed member may move from the front toward the fuel cell stack and significantly damage the fuel cell stack.

### SUMMARY OF THE INVENTION

An object of the present invention is to provide a mounting structure of a fuel cell to a vehicle capable of protecting the fuel cell stack from a deformed member at the time of a front or rear collision of the vehicle.

### BRIEF DESCRIPTION OF THE DRAWINGS

The above and other objects, features, and advantages of the present invention will become apparent and will be more readily appreciated from the following detailed description of the preferred embodiments of the present invention in conjunction with the accompanying drawing, in which:

FIG. 1 is a plan view of a front portion of a vehicle where a fuel cell stack is mounted using a mounting structure of a fuel cell stack to a vehicle according to an embodiment of the present invention;

FIG. 2 is a cross-sectional view of the front portion of the vehicle mounted with the fuel cell stack of FIG. 1;

FIG. 3 is a plan view of a vehicle where a fuel cell stack is mounted to each portion of the vehicle using a mounting structure of a fuel cell stack to a vehicle according to another embodiment of the present invention;

FIG. 4 is a cross-sectional view of the vehicle of FIG. 3;

FIG. 5 is a side elevational view of the fuel cell stack used in the mounting structure according to the embodiments of the present invention; and

FIG. 6 is an enlarged cross-sectional view of one portion of the fuel cell stack of FIG. 5.

### DETAILED DESCRIPTION OF THE PREFERRED EMBODIMENTS

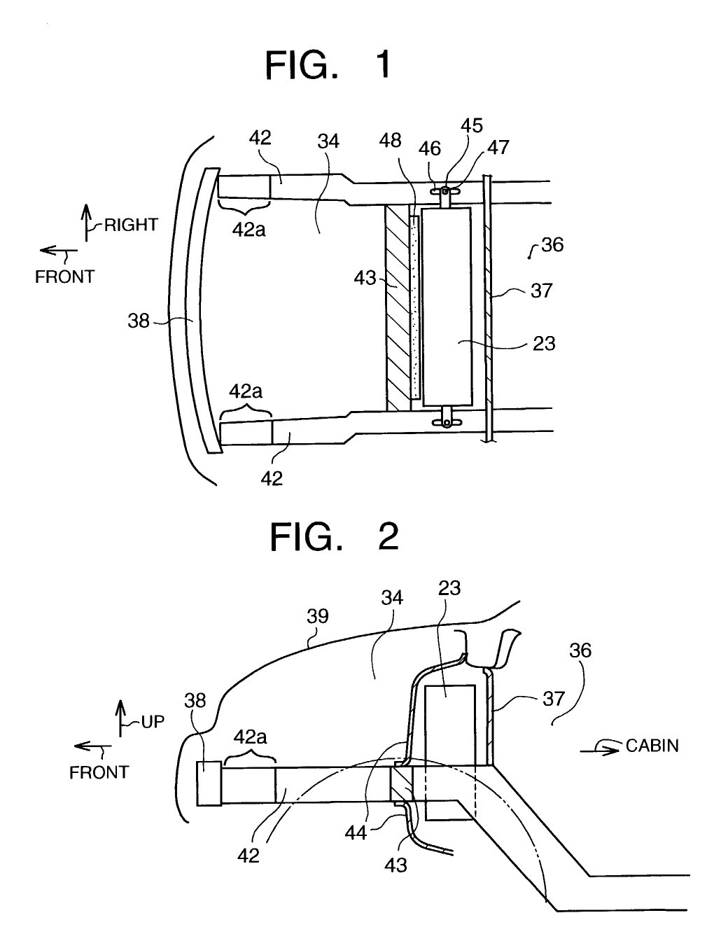

A mounting structure of a fuel cell stack to a vehicle according to embodiments of the present invention will be explained with reference to FIGS. 1-6.

The fuel cell apparatus used in the mounting structure according to the present invention is, for example, a PEFC (Polymer Electrolyte Fuel Cell) apparatus 10, though it is not limited to the PEFC apparatus.

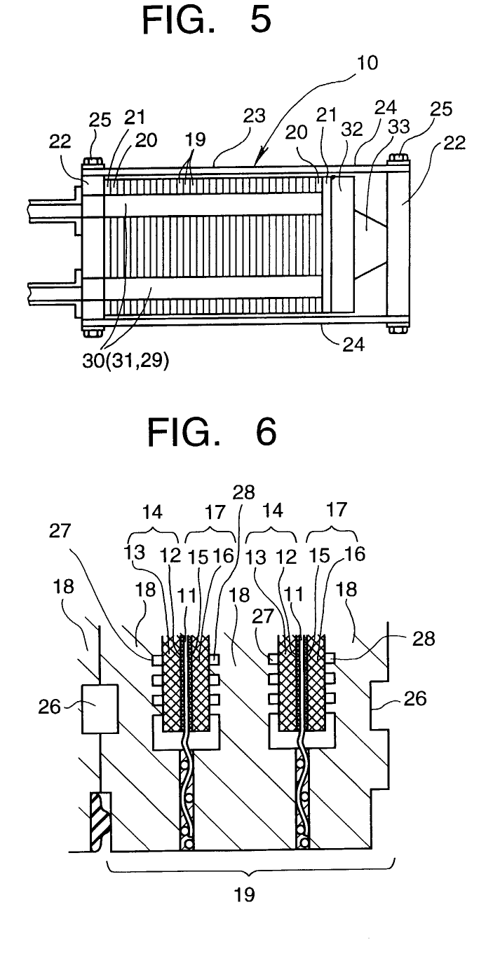

As illustrated in FIGS. 5 and 6, the PEFC apparatus 10 includes a stack of individual fuel cells 23. Each fuel cell includes a membrane-electrode assembly (MEA) and a separator 18. The MEA includes an electrolyte membrane 11 and a pair of electrodes disposed on opposite sides of the membrane 11. The pair of electrodes include (a) an anode 14 provided on one side of the membrane and including a first catalyst layer 12 and (b) a cathode 17 provided on the other side of the membrane and including a second catalyst layer 15. A first diffusion layer 13 may be disposed between the first catalyst layer 12 and a separator 18 provided on an anode side of the MEA, and a second diffusion layer 16 may be disposed between the second catalyst layer 15 and a separator 18 provided on a cathode side of the MEA.

The separator 18 provided on the anode side of the MEA includes a fuel gas (hydrogen) passage 27a formed at a first, MEA-opposing surface and the separator 18 provided on a cathode side of the MEA includes an oxidant gas (oxygen, usually, air) passage 27b formed at a first, MEA-opposing surface. On a second, opposite surface of the separator 18, a coolant (cooling water) passage 26 may be formed. The coolant passage 26 is provided at every fuel cell or at every module, and coolant is caused to flow in the coolant passage 26 to cool the fuel cell apparatus. The separator 18 is made from carbon, electrically conductive synthetic resin, metal, or synthesis thereof.

The fuel gas passage 27, the oxidant gas passage 28, and the coolant passage 26 communicate with a fuel gas manifold 30, an oxidant gas manifold 31, and the coolant manifold 29, respectively. Each manifold is connected to a corresponding piping at an end of a stack 23 of fuel cells.

At least one fuel cell constructs a module 19, and a number of modules are piled, and electrical terminals 20, electrical insulators 21, and end plates 22 are disposed at opposite ends of the pile of modules to construct the stack of fuel cells 23. After tightening the stack of fuel cells 23 between the end plates 22 in a fuel cell stacking direction, the end plates 22 are coupled to the fastening member 24 (for example, a tension plate) extending in the fuel stacking direction outside the pile of fuel cells by bolts 25 or nuts.

At a first end portion of the fuel cell stack 23, a pressure plate 32 and a spring mechanism 33 are disposed to suppress a variance of a load imposed on the fuel cell stack 23, and at a second, opposite end of the fuel cell stack 23, such a pressure plate and a spring mechanism are not disposed.

Since an electric voltage of one fuel cell is about 1 volt, in order to obtain the electric voltage of about 400 volt necessary to a vehicle, two piles of fuel cells each having about 200 fuel cells layered in series need to be provided. The two piles of fuel cells are arranged in parallel with each other and are electrically connected in series with each other. The parallelly arranged two piles of fuel cells are disposed between the opposite common end plates 22 to construct the stack 23 of fuel cells.

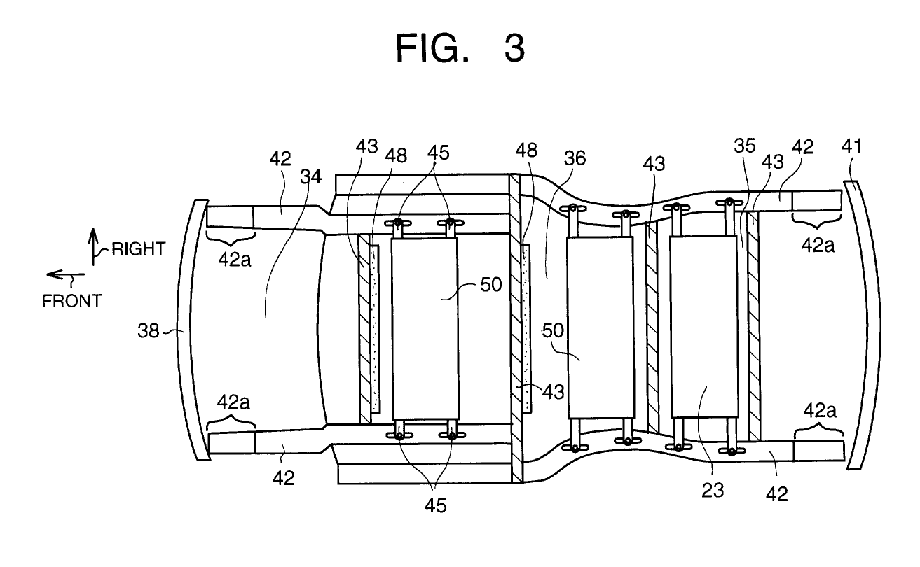

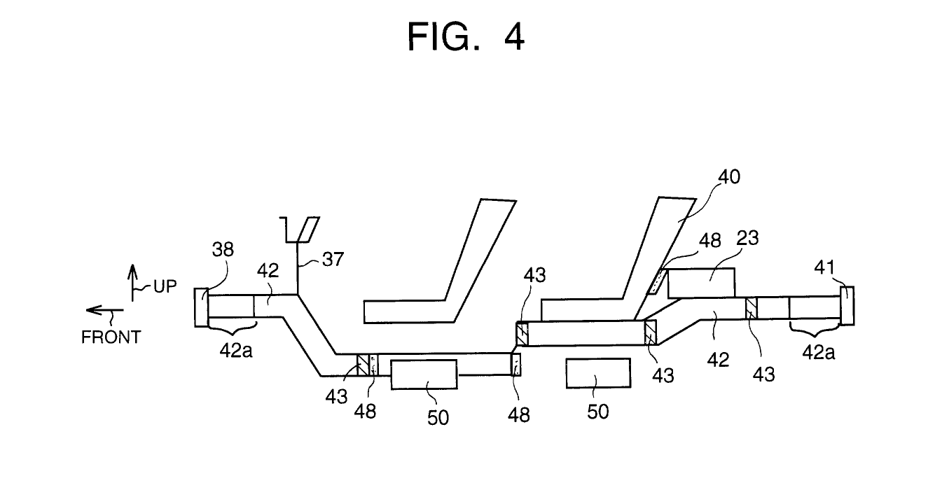

As illustrated in FIGS. 1-4, the vehicle includes a cabin 36, a front compartment 34 (usually called as an engine compartment) located in front of the cabin 36, and a rear compartment 35 (usually called as a luggage room) located in a rear of the cabin 36. The fuel cell stack 23 is mounted in at least one of the front compartment 34 and the rear compartment 35. The fuel cell stack 23 is located close to the cabin 36 in at least one of the front compartment 34 and the rear compartment 35. As illustrated in FIGS. 3 and 4, the fuel cell stack 23 may be disposed under a floor of the vehicle, and such an under floor fuel cell stack 23 is denoted by reference numeral 50.

In a case where the fuel cell stack 23 is disposed in the front compartment 34, the fuel cell stack 23 is disposed at a rearmost portion of the front compartment 34, i.e., at a position close to a dashboard 37. The position is located at a rear of a front bumper 38 and beneath a hood 39. In a case where the fuel cell stack 23 is disposed in the rear compartment 35, the fuel cell stack 23 is disposed at the front portion of the rear compartment 35, i.e., at a position behind a rear seat 40. The position is in front of a rear bumper 41.

The fuel cell stack 23 is mounted to and fixed to a vehicle side member 42 which includes a front side member and a rear floor side member. In the case of the front compartment, the fuel cell stack 23 is fixed to the front side member, and in the case of the rear compartment, the fuel cell stack 23 is fixed to the rear floor side member.

The vehicle side member may have an energy absorbing portion 42a, i.e., a crushable portion for vehicle collision. The fuel cell stack 23 is mounted in the compartments 34 and 35 at a position closer to the cabin 35 than the energy absorbing portion 42a. The front side member has the energy absorbing portion 42a at a front portion of the front side member. In the case of the front compartment, the fuel cell stack 23 is mounted to the front side member at a rear of the energy absorbing portion 42a. The rear floor side member has the energy absorbing portion 42a at a rear portion of the rear floor side member. In the case of the rear compartment, the fuel cell stack 23 is positioned in front of the energy absorbing portion 42a.

The vehicle has a right-and-left direction perpendicular to the front-and-rear direction, and the fuel cell stack 23 has a fuel cell stacking direction perpendicular to a fuel cell plane. The fuel cell stack 23 is mounted to the vehicle side member 42 of the vehicle with the fuel cell stacking direction directed in the right-and-left direction of the vehicle.

In the case where the fuel cell stack 23 having a plurality of piles of fuel cells parallel to each other is disposed in the front compartment 34, the fuel cell stack 23 is disposed such that the piles of fuel cells each extending horizontally are disposed vertical to each other. By this arrangement, the fuel cell stack 23 can be located farther away from front of the vehicle than in the case where the piles of fuel cells each extending horizontally are disposed horizontal to each other. In the case where the fuel cell stack 23 is disposed at a position other than in the front compartment, since a large space is not available in the vertical direction, the piles of fuel cells may be disposed horizontal to each other.

The vehicle includes a vehicle cross member 43. The vehicle cross member 43 is located farther from the cabin 36 than the fuel cell stack 23. The vehicle cross member 43 extends in the right-and-left direction of the vehicle and is fixed to the vehicle side member 42 at opposite ends of the vehicle cross member 43. The vehicle cross member 43 is provided at a position close to the fuel cell stack 23. In the case where the fuel cell stack 23 is disposed in the front compartment 34, the vehicle cross member 43 is provided in front of the fuel cell stack 23. In the case where the fuel cell stack 23 is disposed in the rear compartment 35, the vehicle cross member 43 is provided at a rear of the fuel cell stack 23.

Preferably, a cover 44 covering the fuel cell stack 23 from a side opposite to the cabin 36 is provided. The cabin 36 may have a strengthening rib. In the case where the fuel cell stack 23 is disposed in the front compartment 34, the cover 36 covers the fuel cell stack 23 from the front side, and the fuel cell stack 23 is located in a closed space defined the cover 44 and the dashboard 37.

The fuel cell stack 23 is mounted via a mount 45 having a force limiter to the vehicle side member 42. The mount 45 having a force limiter supports the fuel cell stack 23 from the vehicle side member 42 such that when a load exceeding a predetermined load acts on the mount 45, the mount 45 allows the fuel cell stack 23 to slide relative to the vehicle side member 42. For example, the force limiter of the mount 45 includes a slit 46 formed in the vehicle side member 42 and a bolt 47 extending through the slit 46. A fastening load of the bolt 47 is determined such that at the predetermined load the mount 45 begins to slip relative to the vehicle side member 42. This slit-and-bolt structure may be replaced by another structure which includes a slit having a throttled portion in a longitudinal direction of the slit and a bolt passing through the throttled portion of the slit deforming the throttled portion when a load exceeding a predetermined load acts on the bolt.

In the case where the fuel cell stack 23 is fixed to the vehicle side member 42 via the mount 45 having a force limiter, a bumper 48 for stopping the fuel cell stack 23 with a cushion is provided at an end of a slide movement of the fuel cell stack 23 allowed by the mount 45. The bumper 48 is provided between the fuel cell stack 23 and the vehicle cross member 43 or between the fuel cell stack 23 and the cover 44. The bumper 48 is provided on the side of the vehicle cross member 43 and the cover 44. Between the fuel cell stack 23 and the bumper 48, a space for allowing the fuel cell stack 23 to move is provided.

Next, technical advantages of the mounting structure of a fuel cell stack to a vehicle according to the present invention will be explained.

First, since the fuel cell stack 23 is located close to the cabin 36 in the at least one of the front compartment 34 and the rear compartment 35, a crush area (an energy absorbing area of the vehicle due to deformation of the energy absorbing portion of the vehicle side member) is as large as possible. As a result, the fuel cell stack 23 is effectively protected from a deformed member invading toward the fuel cell stack. Such an invading member is prevented from colliding with the fuel cell stack 23 to cause a dislocation of fuel cells to each other and a leakage of fluids. Though the fuel cell stack 23 is a heavy apparatus, since the heavy apparatus is located in a longitudinally central portion of the vehicle, stability and controllability of the vehicle will be improved compared to a case where the heavy apparatus is located at a longitudinal end of the vehicle.

Second, since the fuel cell stack 23 is located closer to the cabin 36 than the energy absorbing portion 42a of the vehicle side member 42, even when the vehicle side member 42 is deformed at the energy absorbing portion 42a at a time of a vehicle collision, the deformed member is unlikely to invade up to the fuel cell stack 23. As a result, the fuel cell stack 23 is protected from the invading deformed member.

Third, since the fuel cell stack 23 is mounted to the vehicle with the fuel cell stacking direction directed in the right-and-left direction of the vehicle, the longitudinal direction of the fuel cell stack 23 is directed in the right-and-left direction of the vehicle so that the disposition of the fuel cell stack 23 close to the cabin 36 becomes possible. If the fuel cell stack 23 is directed in the front-and-rear direction of the vehicle, the fuel cell stack will extend up to the energy absorbing portion 42a and a deformed member will easily collide with and damage the fuel cell stack. This collision can be prevented in the present invention.

Fourth, since the vehicle cross member 43 is located farther from the cabin 36 than the fuel cell stack 23 and close to the fuel cell stack 23, even if the deformed member invades toward the fuel cell stack 23, the deformed member will be stopped by the vehicle cross member 43. As a result, the fuel cell stack 23 will be protected by the invading deformed member. Though in a conventional vehicle a vehicle cross member is not located at that position, by changing the position of the vehicle cross member to that position of the present invention, the fuel cell stack 23 can be protected.

Fifth, since the cover 44 is provided, the fuel cell stack 23 is intercepted from a space outside the cover 44 so that the fuel cell stack 23 is further protected from the invading deformed member at the time of a vehicle collision. Such cover 44 has a heat-holding effect so that the fuel cell stack 23 will be prevented from icing of product water and cooling water at low temperatures. Further, the cover 44 protects the fuel cell stack 23 from stones and water from a road.

Sixth, since the fuel cell stack 23 is mounted to the vehicle side member 42 via the mount 45 having a force limiter, when an acceleration exceeding the predetermined one acts on the fuel cell stack 23 at the time of a vehicle collision, the fuel cell stack 23 slides relative to the vehicle side member 42 and the inertial acceleration acting on the fuel cell stack 23 will not increase further. As a result, a damage of the fuel cell stack 23 due to the inertial acceleration will be suppressed. Since the fuel cell stack 23 is mounted with the longitudinal direction thereof directed in the right-and-left direction of the vehicle, the inertial force acts in a direction parallel to the fuel cell plane. Therefore, when the inertial force acts on the fuel cell stack 23 in the direction parallel to the fuel cell plane, any dislocation between the fuel cells at the fuel cell plane has to be prevented. Due to the force limiter, the inertial force acting on the fuel cell stack 23 is prevented from increasing above the predetermined force, and no dislocation between the fuel cells will occur.

Last, in the mounting structure allowing such a slide by the force limiter, when the slide amount is large, a load will be caused in a piping, etc. In order to suppress it, it is necessary to restrict the slide amount. However, if a stopper for colliding with the fuel cell stack and stopping the slide movement of the fuel cell stack is provided, the fuel cell stack will be damaged due to a shock of the collision. For suppressing such a damage, the bumper 48 is provided. The fuel cell stack 23 can be stopped by the bumper 48 without a large shock at the end of the slide of the fuel cell stack 23 allowed by the mount.

Although the present invention has been described with reference to specific exemplary embodiments, it will be appreciated by those skilled in the art that various modifications and alterations can be made to the particular embodiments shown without materially departing from the novel teachings and advantages of the present invention. Accordingly, it is to be understood that all such modifications and alterations are included within the spirit and scope of the present invention as defined by the following claims.

What is claimed is:

1. A mounting structure of a fuel cell stack to a vehicle comprising:
a vehicle including a cabin, a front compartment located in front of said cabin, and a rear compartment located in a rear of said cabin; and
a fuel cell stack mounted in at least one of said front compartment and said rear compartment,
wherein said fuel cell stack is located close to said cabin in said at least one of said front compartment and said rear compartment.

2. A mounting structure of a fuel cell stack to a vehicle comprising:
a vehicle including a cabin, a front compartment located in front of said cabin, a rear compartment located in a rear of said cabin, and a vehicle side member having an energy absorbing portion; and
a fuel cell stack mounted in at least one of said front compartment and said rear compartment,
wherein said fuel cell stack is located closer to said cabin in said at least one of said front compartment and said rear compartment than said energy absorbing portion of said vehicle side member.

3. A mounting structure according to any one of claims 1 and 2, wherein said vehicle has a right and left direction and said fuel cell stack includes a fuel cell stacking direction, said fuel cell stack being mounted to said vehicle with said fuel cell stacking direction directed in said right and left direction of said vehicle.

4. A mounting structure according to any one of claims 1 and 2, wherein said vehicle includes a vehicle cross member, said vehicle cross member being located farther from said cabin than said fuel cell stack.

5. A mounting structure according to any one of claims 1 and 2, further comprising a cover covering said fuel cell stack.

6. A mounting structure according to any one of claims 1 and 2, further comprising a mount having a force limiter, said fuel cell stack being mounted via said mount to said vehicle side member.

7. A mounting structure according to claim 6, further comprising a bumper for stopping said fuel cell stack at an end of a movement of said fuel cell stack allowed by said mount.
